(19) United States
(12) Patent Application Publication
(10) Pub. No.: US 2026/0187691 A1
(43) Pub. Date: Jul. 2, 2026

(54) CORRELATING ITEMS AVAILABLE THROUGH AN ONLINE SYSTEM WITH ITEMS INCLUDED IN A DOCUMENT USING ONE OR MORE MACHINE-LEARNING MODELS

(71) Applicant: Maplebear Inc., San Francisco, CA (US)

(72) Inventors: Prithvishankar Srinivasan, Seattle, WA (US); Varun Garg, Issaquah, WA (US); Anshul Kulshrestha, Pleasanton, CA (US); Shishir Kumar Prasad, San Ramon, CA (US)

(21) Appl. No.: 19/006,888

(22) Filed: Dec. 31, 2024

(51) Int. Cl. G06Q 30/0601

(52) U.S. Cl. CPC G06Q 30/0627; G06Q 30/0641

(57) ABSTRACT

An online system obtains a representation of a document that identifies items included in the document and information associated with items by the document. The online system generates a target embedding for a target item selected from the representation based on attributes of the target item and corresponding values from the representation. Based on the target embedding and embeddings for items available via the online system, the online system selects a set of candidate items. The online system selects a set of item attributes and values for each candidate item and compares the set of item attributes to attributes of the target item and associated values from the representation. Based on the comparison, the online system selects a candidate item corresponding to the target item, allowing presentation of information associated with the target item by the document in conjunction with the selected candidate item via the online system.

### BACKGROUND

Various sources of items distribute documents to customers identifying items available from a source or identifying promotional offers on items by the sources. A document may be a physical document distributed by a source to various customers or may be a digital document electronically distributed to various customers. Such documents include images or text describing items available from a source for acquisition by the user from the source, with a description of an item including one or more attributes of the item and corresponding values of the attributes. Additionally, a document provided to customers by a source may identify promotions or offers for various items offered by the source.

Various online systems allow users to select items from one or more sources to be obtained from the selected one or more sources through interaction with the online system. For example, a user selects one or more items available from a source for inclusion in an order via one or more interfaces generated and presented by the online system. Subsequently, the online system obtains the one or more items included in the order and delivers the obtained items to the customer. For example, the online system allocates an order from a user to a picker who obtains items included in the order from a source and delivers the obtained items to a location included in the order.

While an online system allows user selection of items from a source, the source and the online system may maintain different values for attributes of items, or may maintain different information identifying various items. For example, a source uses identifiers having a particular format to uniquely identify different items, while an online system uses identifiers having an alternative format to uniquely identify different items. As another example, the online system maintains multiple items with some attributes having values matching values of attributes of an item included in the document. Such differences between values for attributes of an item specified by the document and values of item attributes maintained by the online system prevents the online system from accurately identifying an item maintained by the online system corresponding to an item included in the document. This prevents the online system from incorporating information associated with an item in the document with an item maintained by the online system for presentation to users. For example, a document from a source identifies discounted pricing for an item, so without accurately identifying a corresponding item maintained by the online system, the online system is unable to incorporate information associated with an item by a document into one or more interfaces generated by the online system based on items available via the online system.

Further, while an online system may present a document from a source to users of the online system, users to whom the online system presents the document are often unable to select an item in the document for inclusion in an order through interaction with the document. For example, an online system presents an image of the document to a user, allowing the user to review the document, but the user cannot include an item from the document in an order for the online system without accessing different interfaces that identify items based on item attributes of the items maintained by the online system. As users often access the online system using client devices with limited display areas, increasing a number of interfaces for a user to navigate to select one or more items ineffectively uses the limited display area of a client device for users to select items from a source. Leveraging attributes of items included in a document from a source and item attributes the online system maintains for items to identify items maintained by the online system corresponding to items in the document allows the online system to combine information from the document with information about items maintained by the online system, resulting in more efficient presentation of information about items from the online system and from the document through one or more interfaces.

### SUMMARY

In accordance with one or more aspects of the disclosure, an online system enables users to select items offered by one or more sources, which the online system subsequently obtains for the users. For example, the online system receives an order including one or more items and identifies a source from which the items are to be obtained. Subsequently, the online system obtains the selected items from the identified source and delivers the obtained items to a location identified by the order.

To increase a number of items obtained by users or to increase a frequency with which users obtain items, a source may distribute a document to users of the online system (e.g., in the form of a feed). The document includes a group of items preselected by the source and other content, such as images or text, preselected by the source for distribution to multiple users. The document may also identify promotions offered by the source for obtaining items identified by the document. Conventionally, the source mass distributes the document to multiple users, with content included in the document common to each user receiving the physical document. For example, the source mails the document to addresses of users of the online system. As another example, the source provides the document to users of the online system through one or more physical locations of the source that users visit.

For example, the document identifies a group of items offered by the source to increase awareness of the group of items to users of the online system. Additionally, the document may also identify one or more promotions offered by the source, such as discounted prices for one or more items offered by the source or opportunities to obtain combinations of items from the source. Further, certain attributes of one or more items included in the document may differ when a user obtains the item from the source directly or obtains the item from the online system, and the document does not reflect the attributes of the items when obtained via the online system.

To account for information in a document provided by a source to users, the online system receives a representation of the document. In various embodiments, the online system receives a text representation of the document, with the text representation including text information describing one or more items included in the document and attributes included in the document for different items. For example, the text representation includes attributes of each item included in the document. Example attributes of an item include: a source item identifier used by the source to identify an item, a name of the item, a brand associated with the item, a description of the item, a quantity of the item, a unit of measurement for the item, and text proximate to the item in the document. Additional or alternative attributes of each item may be included in the representation of the document in various embodiments. In some embodiments, the online system receives the representation of the document from a third party system that received the document from the source and generated the representation of the document. Alternatively, the online system receives the document from the source and locally generates the representation of the document.

While the representation of the document identifies each item included in the document and attributes of the item, values attributes of an item included in the representation may differ from values of item attributes of items maintained by the online system. For example, a source item identifier for an item in the document differs from an item identifier the online system uses to uniquely identify the item. In another example, the online system maintains various items having values for multiple attributes matching values of attributes of the item in the document, but each having one or more attributes with differing values. For example, the online system maintains multiple items having common values for multiple attributes but different values for a size of the item.

To correlate information from the document for an item included in the document an item maintained by the online system, the online system selects a target item from the representation of the document. In some embodiments, the online system selects multiple target items from the representation of the document. The online system sequentially selects each item from the representation of the document as the target item in various embodiments.

Based on attributes of the target item from the representation of the document, the online system generates a target embedding for the target item. In various embodiments, the online system generates a query comprising attributes of the target item and corresponding values obtained from the representation of the document and generates the target embedding for the target item based on the query. For example, the online system generates a query including identifiers of each of a subset of attributes and corresponding values for the target item from the representation of the document. The online system may maintain a specific subset of attributes from which the target embedding is generated in some embodiments. Hence, the target embedding represents attributes from the representation of the document for the target item in a high-dimensional latent space. The online system may apply an encoder to the attributes and their corresponding values of the target item from the representation to generate the target embedding.

The online system also maintains embeddings for items for which the online system maintains attributes. For example, the online system maintains an item catalog of items available via the online system, with the item catalog including an identifier of an item, attributes of the item, and values of attributes of the item. The online system maintains different item catalogs for different sources of items in various embodiments. The online system generates an embedding for each item included in an item catalog based on attributes and corresponding values of attributes the online system maintains for each item. In some embodiments, the online system stores an embedding for an item in the item catalog as an item attribute of the item. Alternatively, the online system may maintain an index of embeddings for items, with the index including an identifier of an item and an embedding for the item. The online system maintains a specific index of embeddings for each source of items from which the online system obtains items in various embodiments.

Based on the target embedding and embeddings for items, the online system selects a set of candidate items using an approximate nearest neighbor (ANN) model. For example, the online system retrieves an item catalog associated with a source identified from the document and retrieves embeddings for items included in the item catalog. As another example, the online system retrieves an index of embeddings of items associated with the source identified from the document. The online system applies the ANN model to the target embedding and to the retrieved embeddings.

For example, the ANN model determines distances (e.g., Euclidean distances) between the target embedding and embeddings for various items maintained by the online system and ranks the items maintained by the online system items based on the distances between their embeddings and the target embedding. In the ranking, items maintained by the online system having embeddings with smaller distances to the target embedding have higher positions in the ranking. The ANN model items having at least a threshold position in the ranking as the set of candidate items.

Alternatively, the ANN model determines measures of similarity (e.g., cosine similarity, dot product) between the target embedding and embeddings for various items maintained by the online system (e.g., items included in an item catalog, items associated with a source identified from the document) and ranks the items based on the measures of similarity of their embeddings to the target embedding. In the ranking, items maintained by the online system having embeddings with higher measures of similarity have higher positions in the ranking. The ANN model selects items having at least a threshold position in the ranking as the set of candidate embeddings. Hence, the set of candidate items have embeddings that are nearest to the target embedding in a latent space (or that have higher measures of similarity to the target embedding).

While the set of candidate items are similar to the target item, values of different attributes of candidate items in the set may have varying measures of similarity to values of attributes of the target item included in the representation of the document. For example, different candidate items offered by the online system have different numbers of attributes maintained by the online system with values matching values of attributes of the target item from the document. differences between values of item attributes of candidate items and values of attributes of the target item affect relevance of different candidate items to the target item. Selecting candidate items based on distances or measures of similarity between the target embedding and embeddings for items maintained by the online system does not fully account for similarity of values of item attributes of candidate items and values of attributes of the target item from the document.

To account for values of item attributes maintained for candidate items by the online system and values of attributes of the target item from the representation, the online system determines the attributes of the target item and their corresponding values from the representation of the document. For example, the online system identifies a section of the representation of the document corresponding to the target item and extracts attributes and values of the attributes for the target item from the section of the representation. For example, the section of the representation of the document includes structured data comprising pairs of an identifier of an attribute and a value of the attribute; the online system retrieves an identifier of an attribute and the corresponding value associated with the identifier to determine an attribute of the target item and a corresponding value of the attribute. In some embodiments, the online system determines each attribute and associated value included in the representation of the document. Alternatively, the online system maintains a target set of attributes and determines values of each attribute of the target set from the representation of the document.

The online system also retrieves item attributes maintained for each candidate item of the set. In some embodiments, the online system maintains different sets of item attributes for different item categories. The online system determines an item category for a candidate item of the set, determines a set of item attributes associated with the determined item category, and retrieves values for each item attribute of the determined set of item attributes maintained by the online system for the candidate item. In some embodiments, the set of item attributes associated with an item category specifies an importance of item attributes of the set relative to each other. For example, the set of item attributes comprises a ranking, with item attributes with higher positions in the ranking having higher importance to a candidate item. As another example, the set of item attributes associates a weight with each item attribute of the set, with a higher weight for an item attribute indicating a higher importance to a candidate item. Different item attributes may be included in different sets of attributes, allowing the online system to specify different item attributes for items in different item categories.

In various embodiments, the online system retrieves a set of item attributes for each candidate item of the set from an item catalog. For example, the online system maintains an item catalog for a source identified by the document, with the item catalog including an identifier of each item and item attributes associated with each item. The online system identifies an identifier of a candidate item, determines an item category including the candidate item, and selects a set of item attributes associated with the determined item category. The online system retrieves the determined set of item attributes associated with the candidate item from the item catalog. When retrieving a set of item attributes for a candidate item, the online system retrieves an identifier of an item attribute and a value of the item attribute in various embodiments.

Based on the attributes of the target item from the representation of the document and sets of item attributes for each candidate item, the online system selects a candidate item from the set of candidate items through a selection model. In some embodiments, the selection model comprises a generative model that compares values of attributes of the target item to values for each of a set of item attributes for candidate items of the set. The generative model selects a candidate item having item attributes with values most similar to values of attributes of the target item. For example, the online system generates a prompt for a generative model including text having identifiers of attributes of the target item and corresponding values of the attributes, as well as identifiers of each candidate item in conjunction with an identifier of each item attribute of a candidate item and a corresponding value of an item attribute of the candidate item. The prompt also includes an instruction to select a candidate item included in the prompt based on similarity between values of item attributes associated with different candidate items and values of attributes of the target item.

The online system applies the generative model to the prompt, and the generative model selects a candidate item included in the prompt based on similarity between values of attributes of the target item and values of item attributes of candidate items included in the prompt. The generative model determines similarity between values of attributes of the target item and item attributes of candidate items based on relationships between portions of text the generative model previously learned during a pre-training process. A candidate item with a greater number of values for item attributes with higher similarity to values of attributes of the target item is more likely to be selected by the generative model. In various embodiments, the prompt includes information identifying importance of item attributes of a set relative to each other. For example, the prompt includes a set of item attributes of a candidate item in a sequence, with item attributes having higher positions in the sequence having higher relative importance to the candidate item. As another example, the prompt includes a weight associated with each of a set of item attributes for a candidate item, with higher weights indicating higher importances to the candidate item. The generative model accounts for relative importance of item attributes of candidate items when selecting a candidate item, so a candidate item with values for item attributes with higher importances being more similar to attributes of the target item is more likely to be selected.

Applying the generative model to item attributes of candidate items and to attributes of the target item improves accuracy of selection of a candidate item maintained by the online system corresponding to the target item from the representation of the document based on similarities between values of item attributes for candidate items maintained by the online system and values of attributes for the target item from the representation of the document. This increases a likelihood of selecting a candidate item having item attributes with values matching or similar to values of attributes of the target item from the representation of the document. For example, the candidate items include multiple sizes of a particular item, and the generative model compares values of the size for the target item from the representation to the different sizes of the item maintained by the online system to select an item maintained by the online system having a size matching, or most similar to, a size identified for the target item.

Alternatively, the selection model generates a score for each candidate item by comparing item attributes for a candidate item to values of attributes of the target item. For example, a score for a candidate item is larger in response to a larger number of item attributes for the candidate item maintained by the online system having values with higher similarities to values of attributes of the target item from the representation. The importance of an item attribute of a set for a candidate item relative to other item attributes of the set affects an amount by which a score for the candidate item is modified (e.g., increased) in response to a measure of similarity between a value of the item attribute of the candidate item and a value of an attribute of the target item. Hence, a value of an item attribute of a candidate item having a higher importance having a higher measure of similarity to a value of a corresponding attribute of the target item has a greater effect on the score for the candidate item than measures of similarity between values of item attributes with lower importance to the candidate item and values of attributes of the target item. In various embodiments, the selection model accounts for partial matching of a value for an item attribute of a candidate item to a value of an attribute of the target item when determining the score for the candidate item. The online system selects a candidate item of the set having a maximum score as corresponding to the target item.

In various embodiments, the online system generates an interface including at least a portion of the information associated with the target item from the document and item attribute of candidate item. For example, the interface includes a promotional offer included in the document for the target item in conjunction with item attributes identifying the selected candidate item to the online system. In the preceding example, a user may identify the selected candidate item for inclusion in an order based on the information associated with the target item, which corresponds to the selected candidate item, from the document. This allows the interface to combine information associated with an item by the document with a corresponding item available through the online system, enabling the online system to automatically include the information associated with the target item in an interface identifying a corresponding item capable of being obtained via the online system. In various embodiments, the online system stores information associated with the target item from the document as an item attribute of the selected candidate item, allowing subsequent retrieval of the information associated with the target item from the document for presentation to users. For example, the online system includes information associated with the target item as an item attribute associated with the selected candidate item in an item catalog maintained for a source associated with the document.

Hence, the online system automatically incorporates information from the document associated with a target item with a candidate item maintained by the online system that is correlated with the target item. This augments information maintained by the online system for the items available through the online system with information about one or more corresponding items provided by a source of the items via the document. One or more interfaces generated by the online system may automatically incorporate information from a document from a source of items in conjunction with one or more items maintained by the online system corresponding to items included in the document. Including information about one or more items from the document allows the online system to provide additional information about items that the online system obtains from the document that affects interaction by users with an interface generated by the online system.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for selecting one or more items maintained by an online system corresponding to one or more items in a document from a source, in accordance with one or more embodiments.

FIG. 4 illustrates a process flow diagram of a method for selecting one or more items maintained by an online system corresponding to one or more items in a document from a source, in accordance with one or more embodiments.

### DETAILED DESCRIPTION

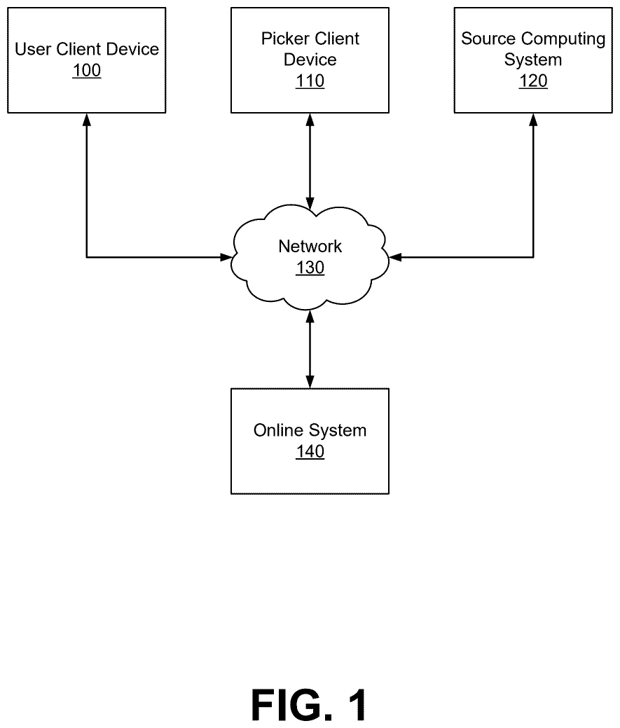

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

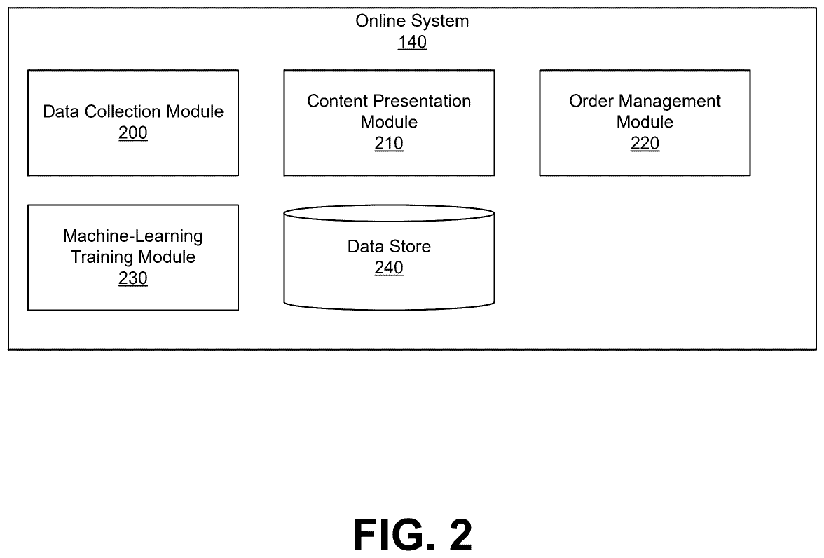

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

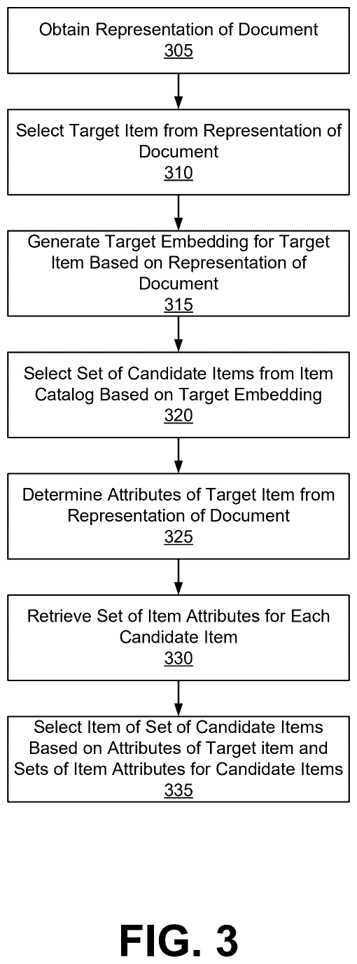

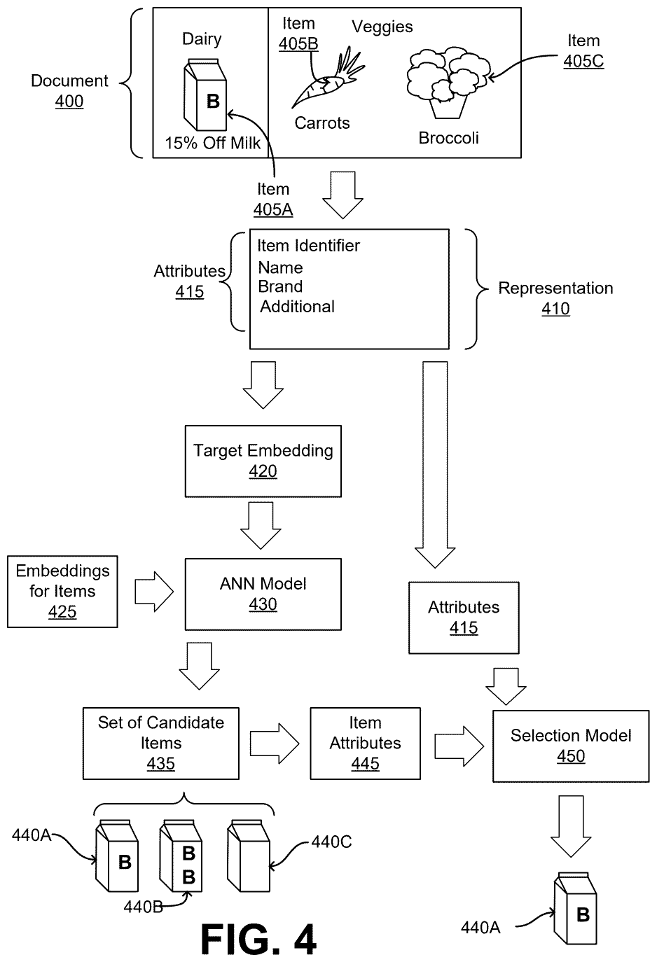

The content presentation module 210 incorporates information associated with an item by a document from a source of one or more items when generating an interface in various embodiments. The document includes a group of items selected by the source and information associated with each item in the document. Information associated with an item in the document includes attributes of the item, values of attributes of the item, a price of the item, a promotional offer for the item, a description of the item, or other information. As further described below in conjunction with FIGS. 3 and 4, the content presentation module 210 obtains a representation of the document. In various embodiments, the representation of the document comprises a text representation of the document including a section corresponding to each item included in the document. A section of the representation includes information associated with an item by the document, such as attributes and values of the item from the document, as well as text associated with the item in the document (e.g., promotional pricing, promotional offers, etc.).

The content presentation module 210 selects a target item from the representation of the document and generates a target embedding for the target item based on attributes of the target item and corresponding values from the document, as further described below in conjunction with FIGS. 3 and 4. Using the target embedding and embeddings the online system 140 maintains for items available via the online system 140, the content presentation module 210 selects a set of candidate items. For example, the content presentation module 210 applies an approximate nearest neighbor (ANN) to the target embedding and to embeddings for items available via the online system 140 to select the set of candidate items, as further described below in conjunction with FIGS. 3 and 4.

For each candidate item, the content presentation module 210 retrieves item attributes and corresponding values stored by the online system 140. By comparing item attributes and corresponding values for each candidate item to attributes of the target item and corresponding values from the document, the content presentation module 210 selects a candidate item to correlate with the target item. In some embodiments, the content presentation module 210 applies a generative model, such as a large language model (LLM), to a prompt including attributes of the target item and corresponding values, identifiers of each candidate item, and item attributes of each candidate item with corresponding values. The generative model selects a candidate item based on values of item attributes matching, or similar to, item attributes and corresponding values of the candidate items, as further described below in conjunction with FIGS. 3 and 4. Alternatively, the content presentation module 210 determines a score for each candidate item and the target item, with a score for a candidate content item based on a measure of similarity between values of item attributes of the candidate item and values of attributes of the target item from the representation of the document.

The content presentation module 210 generates one or more interfaces for a user that include information associated with the target item included in the document in combination with one or more item attributes and values of the selected candidate item corresponding to the target item. For example, the interface includes text associated with the target item from the document in conjunction with an identifier of the selected candidate item and one or more values of item attributes the online system 140 maintains for the selected candidate item. In some embodiments, the content presentation module 210 stores information associated with the target item by the document in association with the selected candidate item, simplifying subsequent retrieval of the information associated with the target item for subsequent presentation in conjunction with the selected candidate item in an interface. For example, the content presentation module 210 stores information associated with the target item by the document as an item attribute of the selected candidate item maintained in an item catalog. The content presentation module 210 may store an indication of a source associated with the document in conjunction with the information associated with the target item by the document, to limit subsequent presentation of the information associated with the target item by the document to interfaces based on the source.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In various embodiments, the machine-learning training module 230 trains one or more encoders to generate embeddings. For example, the machine-learning training module 230 trains a query encoder to receive a combination of attributes of an item and to generate an embedding representing the combination in a high-dimensional latent space. Similarly, the machine-learning training model may train an item encoder to generate an embedding of an item based on item attributes of the item and values of the item attributes. The iterative process further described above may be used to train the query encoder and the item encoder in various embodiments based on training examples of queries and training examples of items, respectively.

Additionally, the machine-learning training module 230 trains one or more approximate nearest neighbor (ANN) models to identify items based on embeddings. In some embodiments, the ANN model determines distances between a target embedding and additional embeddings and ranks the additional embeddings by their distances. Additional embeddings with smaller distances to the target embedding have higher positions in the ranking. The ANN model selects additional embeddings having at least a threshold position in the ranking. In other embodiments, the ANN model determines measures of similarity (e.g., cosine similarity, dot product) between a target embedding and additional embeddings and ranks the additional embeddings by their distances. Additional embeddings with larger measures of similarity to the target embedding have higher positions in the ranking. The ANN model selects additional embeddings having at least a threshold position in the ranking.

The machine-learning training module 230 trains or obtains one or more generative models in some embodiments. A generative model, such as a large language model (LLM), receives an input including a prompt and generates output based on the received input. For example, a generative model is a large language model (LLMs) previously trained on a large text corpus to learn relationships between different portions of text, such as between different words. Based on the previously learned relationships, the LLM generates output text from text received as input based on a prompt received as input. For example, a generative model receives a prompt including one or more formatting instructions and text data as input and generates output text in a format specified by the one or more formatting instructions and based on the input text and previously learned relationships between various texts.

In various embodiments, the machine-learning training module 230 trains or obtains one or more models for extracting text from an image. For example, the machine-learning training module 230 obtains one or more optical character recognition models that extract text from an image. As another example, the machine-learning training module 230 obtains a multimodal large language model (LLM) that receives input having a particular mode or type and generates output having an alternative mode or type. For example, a multimodal LLM receives an image as an input and generates text output based on the input image. The machine-learning training module obtains or trains multiple models that extract text from an image in various embodiments.

In various embodiments, the machine-learning training module 230 obtains a visual language model comprising a multimodal generative model that receives an image and text data as input. The visual language model generates an output based on the received image and text data. For example, the visual language model generates text data based on the received image and text data. As another example, the visual language model generates an output image based on the received image and text data. The visual language model is pre-trained on a set of multimodal training data, with the multimodal training data comprising an image and text corresponding to the image. Text corresponding to an image in the multimodal training data may be captions describing the image, labels of objects included in the image, or other descriptive information about the image. In some embodiments, the visual language model is pre-trained to perform one or more specific tasks, such as visual question answering, where the visual language model receives an image and a question about the image and generates an answer to the question based on the image. Pre-training of the visual language model for visual question answering may be performed by applying the visual language model to training examples each including a question and an image, with each training example labeled with an answer corresponding to the question included in the training example.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

In some embodiments, the data store 240 maintains one or more item catalogs. An item catalog includes entries for each item available via the online system 140. An entry for an item includes an identifier of the item, one or more item attributes or the item, and values for the item attributes. In some embodiments, the data store 240 maintains a separate item catalog for each source from which the online system 140 obtains items, providing different item catalogs for different sources. Alternatively, the data store 250 maintains an item catalog including items available from various sources, with an item attribute of an item specifying a source from which the item is obtained.

FIG. 3 is a flowchart of a method for selecting one or more items maintained by an online system corresponding to one or more items included in a document from a source, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

A source offers various items for acquisition by a user. For example, a source is a physical location from which a user obtains one or more physical items. As another example, a source is a server or another computer system providing digital items that a user obtains from the source via a user client device 100 or another client device. To simplify acquisition of items from one or more sources, an online system 140 may identify items from one or more sources to a user. In various embodiments, the user selects a source via the online system 140 and selects one or more items from the selected source through the online system 140. Subsequently, the online system 140 obtains the selected items from the source and delivers the selected items to a location identified by the user.

To increase a number of items obtained by users, or to increase a frequency with which users obtain items, a source may distribute a document to users of the online system 140. The document includes a group of items preselected by the source and other content, such as images or text, preselected by the source for distribution to multiple users. For example, a document identifies a group of items offered by the source to increase awareness of the group of items to users of the online system 140. Additionally or alternatively, a document may identify one or more promotions for one or more items offered by the source, such as discounted prices for one or more items identified by the document or opportunities to obtain combinations of items from the source. Identifying items or promotions to users of the online system 140 via a document allows a source to increase a number of the users who visit a physical location of the source or who access a third party system associated with the source via the online system 140 or through another application executing on a user client device 100.

A document from a source also includes attributes of items included in the document. For example, the document includes a name, a description, a quantity, a size, a unit of measurement, or other attributes describing an item included in the document. Further, the document may include a source identifier for an item included in the document that uniquely identifies the item to the source. Additionally, the document includes information associated with one or more items in the document. Information associated with an item includes pricing information from the source for the item included in the document. Pricing information for an item included in the document may include discounts or promotional pricing offered by the source for the item. Values of certain attributes of one or more items included in the document may differ when a user obtains the item from the source directly or obtains the item from the online system 140, so values of attributes the online system 140 maintains for one or more items included in the document do not match values of attributes for items included in the document. As one or more interfaces generated by the online system 140 include information the online system 140 maintains for items, the interfaces conventionally do not present information about items included in the document to users. This prevents the interfaces generated by the online system 140 from displaying information associated with items that a source provides via a document, so interfaces conventionally generated by the online system 140 are unable to leverage information about items that a source specifies through the document.

To present information in a document provided by a source to users via one or more interfaces, the online system 140 obtains 305 a representation of the document. In various embodiments, the online system 140 obtains 305 a text representation of the document, with the text representation including text describing one or more items included in the document and describing attributes included in the document for different items. For example, the text representation includes attributes of each item included in the document. In various embodiments, the text representation includes a section for each item included in the document, with the section for an item including attributes of the item included in the document. Example attributes of an item include: a source item identifier used by the source to identify an item, a name of the item, a brand associated with the item, a description of the item, a quantity of the item, a unit of measurement for the item, and text proximate to the item in the document. The representation also includes a value of each attribute of an item included in the document. Attributes of an item in the text representation include pricing information or other text associated with the item by the document. Additional or alternative attributes of each item may be included in the representation of the document in various embodiments. In some embodiments, the online system 140 obtains 305 the representation of the document from a third party system that generated the representation of the document. Alternatively, the online system 140 receives the document from the source and locally generates the representation of the document. In other embodiments, the online system 140 obtains 305 the representation from the source.

While the representation of the document identifies each item included in the document and attributes of the item, values of attributes of an item included in the representation may differ from values of item attributes of items maintained by the online system 140. For example, a source item identifier for an item in the document differs from an item identifier the online system 140 uses to uniquely identify the item. As another example, the representation of the document includes an error in one or more attributes of an item in the document, so the online system 140 is unable to identify locally stored information describing the item to the online system 140. In another example, a value of a size of an item from the document differs from a size of one or more items maintained by the online system 140 that have values of other attributes matching values of attributes of the item in the document. Without information the online system 140 uses to identify an item within the document, information about an item from the document is unable to be included in an interface generated by the online system 140 along with one or more items from the source.

To correlate information from the document associated with an item with an item maintained by the online system 140, the online system 140 selects 310 a target item from the representation of the document. In some embodiments, the online system 140 selects 310 multiple target items from the representation of the document. The online system 140 may sequentially select 310 each item from the representation of the document as the target item in various embodiments.

Based on attributes of the target item and values for the attributes from the representation, the online system 140 generates 315 a target embedding for the target item. In various embodiments, the online system 140 generates a combination of attributes of the target item and values of the attributes of the target item from the representation of the document, and generates 315 the target embedding based on the combination. For example, the online system 140 generates a query comprising attributes of the target item and values of the attributes obtained from the representation of the document, and generates 315 an embedding for the query as the target embedding. In an example, the online system 140 generates a query including values for each of a set of attributes from the representation of the document for the target item, and generates 315 the target embedding from the query. The online system 140 may maintain a specific set of attributes for generating the target embedding in various embodiments and retrieve each attribute of the specific set and corresponding values for each attribute of the specific set from the representation of the document. Hence, the target embedding represents attributes and values of attributes included in the representation of the document included for the target item in a high-dimensional latent space.

In some embodiments, the online system 140 trains and maintains a bi-encoder architecture including two towers, with each tower comprising a transformer-based machine-learning model. A tower of the bi-encoder architecture comprises a query encoder that generates an embedding for a query, while another tower of the bi-encoder architecture comprises an item encoder that generates an embedding for an item. The bi-encoder architecture maintains autonomy between the query encoder and the item encoder. Such autonomy allows the online system 140 to generate an embedding for a query independent of an item and to generate an embedding for an item independent of a query. In such embodiments, the online system 140 provides the query generated from attributes and corresponding values in the representation of the document for the target item to the query encoder, which generates 315 the target embedding for the target item. Alternatively, the online system 140 uses one or more alternative models to generate 315 the target embedding for the target item based on attributes of the target item and corresponding values obtained from the representation of the document.

Based on the target embedding for the target item, the online system 140 selects 320 a set of candidate items for the target item. Each candidate item is an item included in an item catalog maintained by (or accessible to) the online system 140. The online system 140 generates an embedding for each item in the item catalog, with the embedding for an item representing the item in the high-dimensional latent space in which the target embedding represents the target item. In embodiments where the online system 140 trains and maintains a bi-encoder architecture including two towers, comprising a query encoder and an item encoder, the online system 140 applies the item encoder to attributes of an item maintained by the online system 140 to generate an embedding for the item. For example, the online system 140 generates an embedding for each item included in an item catalog maintained by or accessible to the online system 140. The online system 140 stores an embedding for an item in association with the item in an item catalog in some embodiment. Alternatively, the online system 140 stores an embedding for an item in association with an identifier of the item in an index, so the index maintains pairs of item identifiers and corresponding embeddings.

In various embodiments, the online system 140 applies an approximate nearest neighbor (ANN) model to the target embedding and to embeddings for items to select 320 a set of candidate items for the target item. For example, the online system 140 retrieves an item catalog associated with a source associated with the document or retrieves an index of embeddings of items associated with the source associated with the document. The source may be identified by data within the representation in some embodiments, or the online system 140 receives an identifier of the source in conjunction with the representation. In various embodiments, the ANN model determines distances (e.g., Euclidean distances) between the target embedding and embeddings for various items, ranks the items based on the distances between their embeddings and the target embedding, and selects 320 items having at least a threshold position in the ranking as the set of candidate items. In the preceding example, the ranking includes items with embeddings having smaller distances from the target embedding in higher positions. Alternatively, the ANN model determines measures of similarity (e.g., cosine similarity, dot product) between the target embedding and embeddings for various items (e.g., items included in an item catalog, items associated with a source identified from the document), ranks the items based on the measures of similarity to the target embedding, and selects 320 items having at least a threshold position in the ranking as the set of candidate items. In the preceding example, items with embeddings having higher measures of similarity to the target embedding have higher positions in the ranking. Hence, the ANN model selects 320 a set of candidate items having embeddings most similar to the target embedding (or that have higher measures of similarity to the target embedding).

While selecting 320 the set of candidate items based on distances (or measures of similarity) between the target embedding and embeddings for items selects 320 candidate items nearest to the target embedding in the latent space, values of different attributes of candidate items in the set may have varying similarities to attributes of the target item included in the representation of the document. The online system 140 maintains values for various item attributes of each candidate item, with different candidate items having varying numbers of item attributes with values matching (or similar to) values of attributes of the target item from the document. A number of item attributes with values matching, or similar to, values of attributes of the target item affect which candidate item is likely to correspond to the target item included in the document. Although the online system 140 selects 320 the set of candidate items based on distances or measures of similarity between the target embedding and embeddings for items maintained by the online system 140, selecting 320 the set of the candidate items does not fully account for matches between values of specific item attributes of candidate items and values of specific attributes of the target item.

To account for values of item attributes of candidate items and values of attributes of the target item, the online system 140 determines 325 one or more attributes of the target item and corresponding values from the representation of the document. For example, the online system 140 identifies a section of the representation of the document corresponding to the target item and determines 325 attributes of the target item and values of the attributes of the target item from the section of the representation of the document. For example, the section of the representation of the document corresponding to the target item includes structured data comprising pairs of an identifier of an attribute and a value of the attribute, and the online system 140 retrieves an identifier of an attribute and the corresponding value associated with the identifier to determine 325 an attribute of the target item and a value of the attribute of the target item. In some embodiments, the online system 140 determines 325 each attribute and associated value included in the representation of the document for the target item. Alternatively, the online system 140 maintains a target set of attributes and determines 325 each attribute of the target item and corresponding value from the representation of the document.

Additionally, the online system 140 retrieves 330 a set of item attributes and corresponding values maintained by the online system 140 for each candidate item. In some embodiments, the online system 140 maintains different sets of item attributes for different item categories. The online system 140 determines an item category for a candidate item, determines a set of item attributes associated with the determined item category, and retrieves 330 each item attribute and corresponding value maintained by the online system 140 for each attribute of the determined set of item attributes for the candidate item. For example, a set of item attributes for a first item category includes an item attribute of unit count, providing a number of discrete units included in an item, while a set of item attributes from a second item category includes an item volume to indicate a size of the item. Different item attributes may be included in different sets of item attributes, allowing the online system 140 to specify different item attributes for items in different item categories. Maintaining different sets of item attributes for different item categories allows the online system 140 to account for variations between item attributes used to evaluate different candidate items.

In some embodiments, the set of item attributes associated with an item category specifies a relative importance of item attributes of the set relative to each other. For example, the set of item attributes comprises a ranking of item attributes, with item attributes having a higher position in the ranking having higher importance to an item. As another example, the set of item attributes associates a weight with each item attribute of the set, with a higher weight of an item attribute indicating higher importance to an item. Other information specifying relative importance of different item attributes to each other may be included in a set of item attributes in various embodiments.

In various embodiments, the online system 140 retrieves 330 a set of item attributes and corresponding values for each candidate item of the set from an item catalog. For example, the online system 140 maintains an item catalog for a source identified by the document, with the item catalog including an identifier of each item available from the source, as well as item attributes and corresponding values associated with each item. The online system 140 determines an identifier of a candidate item and retrieves 330 a set of item attributes associated with the identifier of the candidate item from the item catalog. As further described above, the set of item attributes may be determined based on an item category associated with a candidate item.

Based on the attributes of the target item and corresponding values from the representation of the document and sets of item attributes and corresponding values for each candidate item, the online system 140 selects 335 a candidate item from the set of candidate items. The online system 140 applies a selection model to attributes and corresponding values of the target item and to item attributes and corresponding values for candidate items to select 335 the candidate item. In some embodiments, the selection model comprises a generative model, with the generative model selecting 335 a candidate item having item attributes with values most similar to values of attributes of the target item. For example, the online system 140 generates a prompt for the generative model including text having identifiers of attributes of the target item and corresponding values of the attributes of the target item, as well as including identifiers of each candidate item in conjunction with an identifier of each item attribute of a candidate item and a corresponding value of an item attribute of the candidate item. The prompt also includes an instruction to select a candidate item included in the prompt based on similarity between values of item attributes associated with different candidate items and values of attributes of the target item. The online system 140 applies the generative model to the prompt, and the generative model selects 335 a candidate item included in the prompt based on similarity between values of attributes of the target item and values of item attributes of candidate items included in the prompt. The generative model determines similarity between values of attributes of the target item and values of item attributes of candidate items based on relationships between portions of text the generative model previously learned during a pre-training process. A candidate item with values for item attributes matching or similar to values of attributes of the target item is more likely to be selected 335 by the generative model.

In various embodiments, the prompt includes information identifying the importance of item attributes of a set relative to each other. For example, the prompt includes item attributes of a set for a candidate item in a sequence, with item attributes having higher positions in the sequence having higher relative importance to the candidate item. As another example, the prompt includes a weight associated with each item attribute of a set, with higher weights indicating higher relative importance of item attributes to the candidate item. The generative model accounts for the relative importance of item attributes for candidate items when selecting 335 a candidate item, so a candidate item with values for item attributes having higher importance being more similar to attributes of the target item is more likely to be selected 335 by the generative model.

Applying the generative model to item attributes of candidate items and to attributes of the target item allows more accurate selection of a candidate item maintained by the online system 140 corresponding to the target item based on similarities between values of item attributes for candidate items and values of attributes for the target item. This increases a likelihood of selecting 335 a candidate item maintained by the online system 140 having values for item attributes matching, or most similar to, values of attributes of the target item. For example, the set of candidate items include multiple sizes of a particular item for which the online system 140 offers multiple sizes, by selecting 335 a candidate item based on similarity between values of item attributes of the candidate items and the values of attributes of the target item, the online system 140 selects 335 a candidate item having a size matching, or most similar to, a size specified for the target item in the document. Comparing values of item attributes of candidate items and values of attributes mitigates potential errors in selecting 335 a candidate item based on measures of similarity or distances between embeddings caused by different measures of similarity for values of individual item attributes to values for individual attributes of the target item.

Alternatively, the selection model generates a score for each candidate item based on similarity between values of item attributes of the set of item attributes for a candidate item to values of attributes of the target item. The score for a candidate item is higher in response to a greater number of values of attributes of the candidate item having higher measures of similarity to values of attributes of the target item. A measure of similarity between a value of an item attribute and a value of the attribute of the target item is inversely related to a difference between the value of the item attribute and the value of the attribute of the target item; a value of an item attribute with a smaller difference from a value of the value of an attribute of the target item causes a higher measure of similarity between the item attribute and the attribute of the target item. In some embodiments, for item attributes and attributes of the target item with numerical values, the measures of similarity between a value of the item attribute and a value of the attributes of the target item is based on a difference between the value of the item attribute and a value of the attributes of the target item. For item attributes or attributes of the target item having text values, the online system determines an embedding for the item attribute and its value and an additional embedding for the attribute of the target item and its value, with a measure of similarity (or a distance) between the embedding and the additional embedding determining the measure of similarity of the item attribute and the attribute of the target item.

For example, a score for a candidate item is larger in response to a larger number of item attributes of the set for the candidate item having values with higher measures of similarity to values of attributes of the target item. The importance of an item attribute of a set relative to other item attributes of the set also affects an amount by which a score for a candidate item is modified (e.g., increased) based on the measure of similarity between a value of the item attribute of the candidate item and a value of an attribute of the target item. Hence, a candidate item with item attributes with higher importances having values of item attributes matching (or with higher measures of similarity to) values of attributes of the target item have greater effects on the score for the candidate item. The online system 140 selects 335 a candidate item of the set having a maximum score as corresponding to the target item.

To determine a score for a candidate item, the online system 140 maintains a set of rules specifying values for incrementing a score of a candidate item. For example, a rule includes an attribute and specifies one or more amounts for increasing a score, with each amount corresponding to a different range of measures of similarity between a value of the attribute for the target item and a value of the item attribute for a candidate item. Maintaining different rules for different attributes allows the online system 140 to vary how measures of similarity between values for different item attributes of a candidate item to values of the target item affect the score for the candidate item.

Alternatively, the online system 140 trains a scoring model to determine a score based on attributes of a target item and corresponding values of the attributes and corresponding item attributes and values of item attributes of a candidate item. The online system 140 trains the scoring model by generating a training dataset including multiple training examples that each include attributes and corresponding values for a training item as well as item attributes and corresponding values for an additional item. Each training example has a label indicating a training score for the training item.

To train the scoring model, the online system 140 initializes a set of weights comprising the scoring model and applies the scoring model to multiple training examples of the training dataset. Applying the scoring model to multiple training examples updates one or more parameters (e.g., the weights) comprising the scoring model. The parameters comprising the scoring model transform the input data - attributes and values of a training item and item attributes and values of an additional item - into a predicted score for the training item. When applied to a training example, the scoring model generates the predicted score of a training example indicating similarity of the attributes and values of the training item to item attributes and values of an additional item.

For each training example to which the scoring model is applied, the online system 140 generates an error term based on the predicted score of the training example and a label applied to the training example. The error term is larger when a difference between the predicted score for the training example and the label applied to the training example is larger and is smaller when the difference between the predicted score for the training example and the label applied to the training example is smaller. In various embodiments, the online system 140 generates the error term using a loss function based on a difference between the predicted score for the training example and the label applied to the training example using a loss function. Example loss functions include a mean square error function, a mean absolute error, a hinge loss function, and a cross-entropy loss function.

The online system 140 backpropagates the error term to update the set of parameters comprising the scoring model and stops backpropagation in response to the error term, or to the loss function, satisfying one or more criteria. For example, the online system 140 backpropagates the error term through the scoring model to update parameters of the scoring model until the error term has less than a threshold value. For example, the online system 140 may apply gradient descent to update the set of parameters. The online system 140 stores the set of parameters comprising the scoring model on a non-transitory computer readable storage medium after stopping the backpropagation.

In some embodiments, the online system 140 presents the target item and the selected candidate item to a reviewing user, and associates the selected candidate item with the target item in response to receiving a confirmation from the receiving user. In response to not receiving a confirmation from the reviewing user, the online system 140 selects an alternative candidate item and presents the alternative candidate item and the target item to the reviewing user for confirmation. This allows the reviewing user to determine whether a candidate item selected 335 by the online system 140 corresponds to the target item. In some embodiments, the online system 140 determines a probability a candidate item corresponding to the target item, and presents the candidate item and the target item to the reviewing user in response to the probability satisfying one or more criteria (e.g., being within a specific range), allowing the reviewing user to manually evaluate certain candidate items for association with the target item.

In some embodiments, the online system 140 generates an interface including information identifying the selected candidate item and information associated with the target item from the representation of the document. For example, the interface comprises a digital document including information identifying the selected candidate item and a subset of information associated with the target item from the representation of the document. In various embodiments, the digital document includes attributes of the target item determined 325 from the representation of the document, including text associated with the target item by the representation of the document, as well as information identifying the selected candidate item to the online system 140. Additionally, the digital document includes one or more interface elements that, when selected by a user, include the selected candidate item in an order generated by the online system 140. As the target item corresponds to the selected candidate item that is maintained by the online system 140, interacting with an interface element of the digital document allows a user to select the item maintained by the online system 140 corresponding to the target item in the document. This allows the interface to present information included in the document relevant to the item maintained by the online system 140 corresponding to the target item when generating an order and to simplify inclusion of the item maintained by the online system 140 corresponding to the target item in an order.

In some embodiments, the online system 140 selects a candidate item maintained by the online system 140 for each item included in the representation of the document, and generates a digital document based on the document. Such a digital document includes information identifying each candidate item to a user along with information included in the document for each item in the document, as well as information from the document associated with an item corresponding to each candidate item. As the digital document includes items maintained by the online system 140 corresponding to items included in the document as well as information associated with items included in the document, the digital document converts the document into an interface simplifying creation of an order based on information in the document through the online system 140. Combining information associated with items from the document for one or more items with corresponding items maintained by the online system 140 allows generation of an interface identifying items available via the online system 140 in conjunction with information associated with the items obtained from the document. Such a combination allows a single interface to receive selections of items maintained by the online system 140 and to present information the document associates with various items, so the information from the document may affect items a user selects through the interface.

Alternatively or additionally, the online system 140 stores information associated with the target item by the representation of the document in association with the candidate item selected 355 for the target item. For example, the online system 140 stores information associated with the target item by the document in an entry of an item catalog associated with the candidate item selected 335 for the target item. Subsequently, the online system 140 includes at least a portion of the information from the document associated with the target item stored in association with the selected candidate item in an interface in conjunction with information identifying the selected candidate item. For example, an interface comprises search results including items having item attributes that at least partially match a search query, with the candidate item selected 335 for the target item included in the search results; the interface includes at least a portion of the information associated with the target item from the document that the online system 140 stored in association with the selected candidate item. As another example, an interface generated by the online system 140 presents information identifying each of a group of items available from a source and includes information associated with the target item from the document in conjunction with information identifying the candidate item selected 335 for the target item. For example, the interface generated by the online system 140 presents a promotional offer or promotional pricing associated with the target item by the document in conjunction with an identifier of the candidate item selected 335 for the target item.

Hence, the online system 140 automatically incorporates information the document associated with one or more items with corresponding items maintained by the online system 140 to be obtained through the online system 140. This augments information maintained by the online system 140 for items available through the online system 140 with information about one or more corresponding items provided by a source of the items via the document. For example, a document from a source includes promotional offers for various items, and selecting 335 a candidate item available via the online system 140 to include a promotional offer for an item from the document in one or more interfaces displaying an item maintained by the online system 140 corresponding to an item included in the document. Including information about one or more items from the document allows the online system 140 to provide additional information about items that the online system 140 obtains from the document that affects interaction by users with an interface generated by the online system 140.

FIG. 4 is a process flow diagram of a method for selecting one or more items maintained by an online system corresponding to one or more items included in a document from a source. The online system 140 enables users to select items offered by one or more sources, which the online system 140 subsequently obtains for the users. For example, the online system 140 receives an order including one or more items and identifying a source from which the items are to be obtained. Subsequently, the online system 140 obtains the selected items from the identified source and delivers the obtained items to a location identified by the order.

To increase a number of items obtained from a source by users or to increase a frequency with which users obtain items from the source, the source may distribute a document to users of the online system 140. The document includes a group of items preselected by the source and information associated with various items of the group, such as images or text, preselected by the source for distribution to multiple users. Information associated with an item may identify promotions offered by the source for obtaining the items from the source. For example, the document includes modified pricing for one or more items when obtained from the source. Conventionally, the source mass distributes the document to multiple users, with content included in the document common to each user receiving the document. For example, the source mails the document to addresses of users of the online system 140. As another example, the source provides the document to users of the online system 140 through one or more physical locations of the source that users visit. In another example, the source electronically distributes the document to users of the online system 140.

For example, the document identifies a group of items offered by the source to increase a likelihood of users of the online system 140 obtaining one or more items of the group. Additionally, the document may identify one or more promotions offered by the source, such as discounted prices for one or more items offered by the source or opportunities to obtain combinations of items from the source for a reduced price. Values of certain attributes of one or more items included in the document may differ from values for corresponding attributes the online system 140 maintains for corresponding items. For example, the document maintains different prices for items than the online system 140.

In the example of FIG. 4, document 400 includes item 405A, item 405B, and item 405C (also referred to individually or collectively using reference number 405). The document 400 includes information identifying each of item 405A, item 405B, and item 405C. For example, the document 400 includes an image and a name or a description of each of item 405A, item 405B, and item 405C. The document 400 includes one or more attributes and values of attributes for items 405. For example, an attribute of an item 405 comprises a unit of measurement for the item and a value corresponding to the unit of measurement to indicate a size of the item 405. As another example, the document identifies a brand associated with an item 405. The document also includes other information about an item 405, such as a price associated with the item 405 by the source, or a description of a promotional offer the source offers for the item 405. For example, the document 400 includes a description of promotional pricing for item 405A, while including descriptive information of item 405B and item 405C without promotional pricing for item 405A and item 405C. Different attributes or different information may be associated with different items 405 in various embodiments.

To account for information about one or more items in a document provided by a source to users when generating an interface, the online system 140 receives a representation 410 of the document 400. In various embodiments, the online system 140 receives a text representation of the document 400, with the representation 410 including text information describing one or more items 405 included in the document and describing attributes included in the document for different items 405. For example, the text representation 410 includes attributes extracted from the document 400 for each item 405 included in the document 400 and corresponding values. Example attributes of an item 405 include: a source item identifier used by the source to identify the item 405, a name of the item 405, a brand associated with the item 405, a description of the item 405, a quantity of the item 405, a unit of measurement for the item 405, text proximate to the item 405 in the document 400, or other information about the item 405 that is obtained from the document 400. Additional or alternative attributes of each item 405 may be included in the representation 410 of the document 400 in various embodiments. In some embodiments, the online system 140 receives the representation 410 of the document 400 from a third party system that generated the representation 410 of the document 400. Alternatively, the online system 140 receives the document 400 from the source and locally generates the representation of the document 400.

In various embodiments, the representation 410 includes multiple sections, with each section corresponding to a different item 405 included in the document 400. For example, each section includes structured data comprising pairs of an identifier of an attribute 415 of an item 405 corresponding to the section and a value of the attribute 415. In some embodiments, the representation 410 includes a specific group of attributes 415 and corresponding values for each item 405 in a corresponding section. In other embodiments, the representation includes each attribute 415 of an item 405 in the document 400 and corresponding values. Attributes 415 of an item 405 include information about the item 405 obtained from the document 400, such as a promotional price or a text description of a promotional offer for the item 405 described by the document 400.

While the representation 410 of the document 400 identifies each item included in the document, as well as attributes 415 of the item and their corresponding values, values of attributes of an item included in the representation may differ from values of attributes maintained by the online system 140 for various items. For example, a source item identifier for an item 405 in the document 400 differs from an item identifier the online system 140 uses to uniquely identify the item 405. As another example, the representation 410 of the document includes an error in a value of an attribute of an item 405 in the document 400, so the online system 140 is unable to identify a corresponding item with matching values for attributes maintained by the online system 140. In another example, the online system 140 maintains various items having values for multiple attributes matching values of attributes of the item in the document, but each having one or more attributes with differing values. For example, the online system 140 maintains multiple items having common values for multiple attributes but different values for a size of the item 405.

To correlate information from the document 400 for an item 405 included in the document 400 an item maintained by the online system 140, the online system 140 selects a target item from the representation 410 of the document 400. In the example of FIG. 4, the online system 140 selects item 405A as the target item. In some embodiments, the online system 140 selects multiple target items from the representation 410 of the document 400. The online system 140 sequentially selects each item 405 from the representation 410 of the document 400 as the target item in various embodiments.

Based on attributes 415 of the target item from the representation 410 of the document 400, the online system 140 generates a target embedding 420 for the target item. In various embodiments, the online system 140 generates a query comprising attributes 415 of the target item and corresponding values obtained from the representation 410 of the document 400 and generates the target embedding 420 for the target item based on the query. For example, the online system 140 generates a query including identifiers of each of a subset of attributes and corresponding values for the target item from the representation 410. The online system 140 may maintain a specific subset of attributes 415 from which the target embedding 420 is generated in some embodiments. Hence, the target embedding 420 represents attributes 415 from the representation 410 of the document 400 for the target item in a high-dimensional latent space. The online system 140 may apply an encoder to the attributes 415 and their corresponding values of the target item from the representation 410 to generate the target embedding 420, as further described above in conjunction with FIG. 3.

The online system 140 also maintains embeddings 425 for items for which the online system 140 maintains attributes. For example, the online system 140 maintains an item catalog of items available via the online system 140, with the item catalog including an identifier of an item, attributes of the item, and values of attributes of the item. The online system 140 maintains different item catalogs for different sources of items in various embodiments. The online system 140 generates an embedding for each item included in an item catalog based on attributes and corresponding values of attributes the online system 140 maintains for each item. In some embodiments, the online system 140 stores an embedding for an item in the item catalog as an item attribute of the item. Alternatively, the online system 140 may maintain an index of embeddings for items, with the index including an identifier of an item and an embedding for the item. The online system 140 maintains a specific index of embeddings for each source of items from which the online system 140 obtains items in various embodiments.

Based on the target embedding and embeddings 425 for items, the online system 140 selects a set 435 of candidate items using an approximate nearest neighbor (ANN) model 430. For example, the online system 140 retrieves an item catalog associated with a source identified from the document 400 and retrieves embeddings 425 for items included in the item catalog. As another example, the online system 140 retrieves an index of embeddings 425 of items associated with the source identified from the document 400. The online system 140 applies the ANN model 430 to the target embedding 420 and to the retrieved embeddings 425.

For example, the ANN model 430 determines distances (e.g., Euclidean distances) between the target embedding 420 and embeddings 425 for various items maintained by the online system 140 and ranks the items maintained by the online system 140 items based on the distances between their embeddings 425 and the target embedding 420. In the ranking, items maintained by the online system 140 having embeddings 425 with smaller distances to the target embedding 420 have higher positions in the ranking. The ANN model 430 may include only those items having at least a threshold position in the ranking as the set 435 of candidate items.

Alternatively, the ANN model 430 determines measures of similarity (e.g., cosine similarity, dot product) between the target embedding 420 and embeddings 425 for various items maintained by the online system 140 (e.g., items included in an item catalog, items associated with a source identified from the document) and ranks the items based on the measures of similarity of their embeddings 425 to the target embedding 420. In the ranking, items maintained by the online system 140 having embeddings with higher measures of similarity have higher positions in the ranking. The ANN model 430 selects items having at least a threshold position in the ranking as the set 435 of candidate embeddings. Hence, the set 435 of candidate items have embeddings 425 that are nearest to the target embedding 420 in a latent space (or that have higher measures of similarity to the target embedding).

While the set 435 of candidate items are similar to the target item, values of different attributes of candidate items in the set 435 may have varying measures of similarity to values of attributes of the target embedding 420 included in the representation 410 of the document 400. For example, different candidate items offered by the online system 140 have different numbers of attributes maintained by the online system 140 with values matching values of attributes of the target item from the document 400. differences between values of item attributes of candidate items and values of attributes of the target item affect relevance of different candidate items to the target item. Selecting candidate items based on distances or measures of similarity between the target embedding 420 and embeddings 425 for items maintained by the online system 140 does not fully account for similarity of values of item attributes of candidate items and values of attributes 415 of the target item from the document 400.

In the example of FIG. 4, the set 435 of candidate items includes candidate item 440A, candidate item 440B, and candidate item 440C (also referred to individually and collectively using reference number 440). Each candidate item 440 has an embedding in a threshold position of a ranking based on measures of similarity or distances to the target embedding 420. While FIG. 4 shows an example where the set 435 of candidate items includes three candidate items 440, in other embodiments, the set 435 of candidate items includes any number of candidate items 440.

To account for values of item attributes 445 maintained for candidate items by the online system 140 and values of attributes 415 of the target item from the representation 410, the online system 140 determines the attributes 415 of the target item and their corresponding values from the representation 410 of the document 400. For example, the online system 140 identifies a section of the representation 410 of the document 400 corresponding to the target item and extracts attributes and values of the attributes for the target item from the section of the representation 410. For example, the section of the representation 410 of the document 400 includes structured data comprising pairs of an identifier of an attribute and a value of the attribute; the online system 140 retrieves an identifier of an attribute and the corresponding value associated with the identifier to determine an attribute 415 of the target item and a corresponding value of the attribute 415. In some embodiments, the online system 140 determines each attribute 415 and associated value included in the representation 410 of the document 400. Alternatively, the online system 140 maintains a target set of attributes and determines values of each attribute 415 of the target set from the representation 410 of the document 400.

The online system 140 also retrieves item attributes 445 maintained for each candidate item of the set 435. In some embodiments, the online system 140 maintains different sets of item attributes for different item categories. The online system 140 determines an item category for a candidate item of the set 435, determines a set of item attributes 445 associated with the determined item category, and retrieves values for each item attribute 445 of the determined set of item attributes maintained by the online system 140 for the candidate item. In some embodiments, the set of item attributes associated with an item category specifies an importance of item attributes 445 of the set relative to each other. For example, the set of item attributes 445 comprises a ranking, with item attributes 445 with higher positions in the ranking having higher importance to a candidate item. As another example, the set of item attributes associates a weight with each item attribute 445 of the set, with a higher weight for an item attribute 445 indicating a higher importance to a candidate item. Different item attributes 445 may be included in different sets of attributes, allowing the online system 140 to specify different item attributes 445 for items in different item categories.

In various embodiments, the online system 140 retrieves a set of item attributes 445 for each candidate item 440 of the set 435 from an item catalog. For example, the online system 140 maintains an item catalog for a source identified by the document 400, with the item catalog including an identifier of each item and item attributes associated with each item. The online system 140 identifies an identifier of a candidate item, determines an item category including the candidate item, and selects a set of item attributes 445 associated with the determined item category. The online system 140 retrieves the determined set of item attributes 445 associated with the candidate item from the item catalog. When retrieving 330 a set of item attributes 445 for a candidate item 440, the online system 140 retrieves an identifier of an item attribute 445 and a value of the item attribute 445 in various embodiments.

Based on the attributes 415 of the target item from the representation 410 of the document 400 and sets of item attributes 445 for each candidate item 440, the online system 140 selects a candidate item from the set 435 of candidate item 440 through a selection model 450. In some embodiments, the selection model 450 comprises a generative model that compares values of attributes 415 of the target item to values for each of a set of item attributes 445 for candidate items of the set 435. The generative model selects a candidate item having item attributes 445 with values most similar to values of attributes 415 of the target item. For example, the online system 140 generates a prompt for a generative model including text having identifiers of attributes 415 of the target item and corresponding values of the attributes 415, as well as identifiers of each candidate item 440 in conjunction with an identifier of each item attribute 445 of a candidate item 440 and a corresponding value of an item attribute 445 of the candidate item 440. The prompt also includes an instruction to select a candidate item included in the prompt based on similarity between values of item attributes 445 associated with different candidate item 440 and values of attributes 415 of the target item.

The online system 140 applies the generative model to the prompt, and the generative model selects a candidate item included in the prompt based on similarity between values of attributes 415 of the target item and values of item attributes 445 of candidate item 440 included in the prompt. The generative model determines similarity between values of attributes 415 of the target item and item attributes 445 of candidate items based on relationships between portions of text the generative model previously learned during a pre-training process. A candidate item with a greater number of values for item attributes 445 with higher similarity to values of attributes 415 of the target item is more likely to be selected by the generative model. In various embodiments, the prompt includes information identifying the importance of item attributes 445 of a set relative to each other. For example, the prompt includes a set of item attributes of a candidate item 440 in a sequence, with item attributes 445 having higher positions in the sequence having higher relative importance to the candidate item. As another example, the prompt includes a weight associated with each of a set of item attributes for a candidate item 440, with higher weights indicating higher importances to the candidate item 440. The generative model accounts for the relative importance of item attributes of candidate items when selecting a candidate item 440, so a candidate item 440 with values for item attributes with higher importances being more similar to attributes of the target item is more likely to be selected.

Applying the generative model to item attributes 445 of candidate items and to attributes 415 of the target item improves accuracy of selection of a candidate item 440 maintained by the online system 140 corresponding to the target item from the representation 410 of the document 400 based on similarities between values of item attributes 445 for candidate item 440 maintained by the online system 140 and values of attributes 415 for the target item from the representation 410 of the document 400. This increases a likelihood of the selecting a candidate item 440 having item attributes 445 with values matching or similar to values of attributes 415 of the target item from the representation 410 of the document 400. For example, the candidate item 440 include multiple sizes of a particular item, and the generative model compares values of the size for the target item from the representation 410 to the different sizes of the item maintained by the online system 140 to select an item maintained by the online system 140 having a size matching, or most similar to, a size identified for the target item.

Alternatively, the selection model 450 generates a score for each candidate item by comparing item attributes 445 for a candidate item 440 to values of attributes 415 of the target item. For example, a score for a candidate item 440 is larger in response to a larger number of item attributes 445 for the candidate item maintained by the online system 140 having values with higher similarities to values of attributes 415 of the target item from the representation 410. The importance of an item attribute 445 of a set for a candidate item 440 relative to other item attributes 445 of the set affects an amount by which a score for the candidate item 440 is modified (e.g., increased) in response to a measure of similarity between a value of the item attribute 445 of the candidate item 440 and a value of an attribute 415 of the target item. Hence, a value of an item attribute 445 of a candidate item 440 having a higher importance having a higher measure of similarity to a value of a corresponding attribute 415 of the target item has a greater effect on the score for the candidate item 440 than measures of similarity between values of item attributes 445 with lower importance to the candidate item 440 and values of attributes 415 of the target item. In various embodiments, the selection model 450 accounts for partial matching of a value for an item attribute 445 of a candidate item to a value of an attribute 415 of the target item when determining the score for the candidate item. The online system 140 selects a candidate item 440 of the set 435 having a maximum score as corresponding to the target item.

In the example of FIG. 4, the selection model 450 selects candidate item 440A of the set 435 of candidate items as corresponding to the target item, item 405A. Hence, candidate item 440A has a maximum number of item attributes 445 with values matching, or similar to, values of attributes 415 of the target item. In some embodiments, candidate item 440A has a maximum score that is based on importance of different item attributes 445 to candidate item 440A and measures of similarity between values of various item attributes 445 and values of attributes 415 of the target item.

In various embodiments, the online system 140 generates an interface including at least a portion of the information associated with the target item from the document 400 and item attribute 415 of candidate item 440A. For example, the interface includes a promotional offer included in the document 400 for item 405A in conjunction with item attributes identifying candidate item 440A to the online system 140. In the preceding example, a user may select candidate item 440A for inclusion in an order based on the information associated with item 405A, which corresponds to candidate item 440A, from the document 400. This allows the interface to combine information associated with an item by the document 400 with a corresponding item available through the online system 140, enabling the online system 140 to automatically include the information associated with the target item in an interface identifying a corresponding item capable of being obtained via the online system 140. In various embodiments, the online system 140 stores information associated with the target item from the document 400 as an item attribute of the selected candidate item, allowing subsequent retrieval of the information associated with the target item from the document 400 for presentation to users. For example, the online system 140 includes information associated with the target item as an item attribute associated with the selected candidate item in an item catalog maintained for a source associated with the document 400.

Hence, the online system 140 automatically incorporates information the document 400 associated with a target item with candidate item maintained by the online system 140 that is correlated with the target item. This augments information maintained by the online system 140 for the items available through the online system 140 with information about one or more corresponding items provided by a source of the items via the document. One or more interfaces generated by the online system 140 may automatically incorporate information from a document from a source of items in conjunction with one or more items maintained by the online system 140 corresponding to items included in the document. Including information about one or more items from the document allows the online system 140 to provide additional information about items that the online system 140 obtains from the document that affects interaction by users with an interface generated by the online system 140.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, at the computer system, a representation of a document including one or more items available through a source;
extracting, by the computer system, a target item included in the representation of the document;
generating, by the computer system, a target embedding for the target item based on information associated with the target item included in the representation of the document;
selecting a set of candidate items for which the computer system maintains attributes based on the target embedding and embeddings for items for which the computer system maintains attributes;
generating attributes of the target item based on information associated with the target item included in the representation of the document;
retrieving a set of item attributes for each candidate item based on attributes maintained by the computer system for items;
selecting a candidate item of the set of candidate items based on values of the attributes of the target item and values of the sets of item attributes for each candidate item; and
generating an interface including information describing the selected candidate item and information associated with the target item included in the representation of the document.

2. The method of claim 1, wherein selecting the candidate item of the set of candidate items based on values of the attributes of the target item and values of the sets of item attributes for each candidate item comprises:
applying a generative model to a prompt including attributes of the target item and corresponding values of the attributes of the target item, and identifiers of each candidate item of the set in conjunction with an identifier of each item attribute of a candidate item and a corresponding value of an item attribute of the candidate item, the prompt including an instruction to select a candidate item based on similarity between values of attributes of the target item and values of item attributes of candidate items.

3. The method of claim 2, wherein the prompt further includes relative importance of item attributes of a candidate item, and the instruction is to select a candidate item based on similarity between values of attributes of the target item and values of item attributes of candidate items and relative importance of item attributes to each other.

4. The method of claim 2, wherein selecting the candidate item of the set of candidate items based on values of the attributes of the target item and values of the sets of item attributes for each candidate item comprises:
generating a score for each candidate item of the set, a score for a candidate item based on a measure of similarity between a value of each attribute of the target item, and a value of an item attribute of the target item; and
selecting the candidate item of the set of candidate items based on the scores.

5. The method of claim 4, wherein generating the score for each candidate item of the set, the score for a candidate item based on the measure of similarity between the value of each attribute of the target item, and the value of an item attribute of the target item comprises:
generating the score for each candidate item of the set, the score for the candidate item based on the measure of similarity between a value of each attribute of the target item and the value of an item attribute of the target item, as well as relative importance of item attributes to each other.

6. The method of claim 1, wherein selecting the set of candidate items for which the computer system maintains attributes based on the target embedding and embeddings for items for which the computer system maintains attributes comprises:
generating a distance between the target embedding and each of the embeddings for items for which the computer system maintains attributes;
ranking the items for which the computer system maintains attributes based on the distances; and
selecting items for which the computer system maintains attributes having at least a threshold position in the ranking.

7. The method of claim 1, wherein selecting the set of candidate items for which the computer system maintains attributes based on the target embedding and embeddings for items for which the computer system maintains attributes comprises:
generating a measure of similarity between the target embedding and each of the embeddings for items for which the computer system maintains attributes;
ranking the items for which the computer system maintains attributes based on the measures of similarity; and
selecting items for which the computer system maintains attributes having at least a threshold position in the ranking.

8. The method of claim 1, wherein generating the interface including information describing the selected candidate item and information associated with the target item included in the representation of the document comprises:
storing information associated with the target item included in the representation of the document in association with the selected candidate item;
retrieving one or more item attributes of the selected candidate item and at least a portion of the information associated with the target item included in the representation of the document; and
generating the interface based on the one or more item attributes of the selected candidate item and at least a portion of the information associated with the target item included in the representation of the document.

9. The method of claim 1, wherein retrieving the set of item attributes for each candidate item based on attributes maintained by the computer system for items comprises:
generating an item category maintained by the computer system including a candidate item;
generating a set of item attributes associated with the generated item category; and
retrieving the generated set of item attributes associated with the generated item category for the candidate item.

10. The method of claim 1, wherein generating, by the computer system, the target embedding for the target item based on information associated with the target item included in the representation of the document comprises:
generating a combination of identifiers of attributes of the target item included in the representation of the document and corresponding values of the attributes of the target item; and
generating the target embedding based on the combination.

11. A computer program product comprising a non-transitory computer readable storage medium having instructions encoded thereon that, when executed by a processor, cause the processor to perform steps comprising:
receiving, at an online system, a representation of a document including one or more items available through a source;
extracting, by the online system, a target item included in the representation of the document;
generating, by the online system, a target embedding for the target item based on information associated with the target item included in the representation of the document;
selecting a set of candidate items for which the online system maintains attributes based on the target embedding and embeddings for items for which the online system maintains attributes;
generating attributes of the target item based on information associated with the target item included in the representation of the document;
retrieving a set of item attributes for each candidate item based on attributes maintained by the online system for items;
selecting a candidate item of the set of candidate items based on values of the attributes of the target item and values of the sets of item attributes for each candidate item; and
generating an interface including information describing the selected candidate item and information associated with the target item included in the representation of the document.

12. The computer program product of claim 11, wherein selecting the candidate item of the set of candidate items based on values of the attributes of the target item and values of the sets of item attributes for each candidate item comprises:
applying a generative model to a prompt including attributes of the target item and corresponding values of the attributes of the target item, and identifiers of each candidate item of the set in conjunction with an identifier of each item attribute of a candidate item and a corresponding value of an item attribute of the candidate item, the prompt including an instruction to select a candidate item based on similarity between values of attributes of the target item and values of item attributes of candidate items.

13. The computer program product of claim 12, wherein the prompt further includes relative importance of item attributes of a candidate item, and the instruction is to select a candidate item based on similarity between values of attributes of the target item and values of item attributes of candidate items and relative importance of item attributes to each other.

14. The computer program product of claim 12, wherein selecting the candidate item of the set of candidate items based on values of the attributes of the target item and values of the sets of item attributes for each candidate item comprises:
generating a score for each candidate item of the set, a score for a candidate item based on a measure of similarity between a value of each attribute of the target item, and a value of an item attribute of the target item; and
selecting the candidate item of the set of candidate items based on the scores.

15. The computer program product of claim 14 wherein generating the score for each candidate item of the set, the score for a candidate item based on the measure of similarity between the value of each attribute of the target item, and the value of an item attribute of the target item comprises:
generating the score for each candidate item of the set, the score for the candidate item based on the measure of similarity between a value of each attribute of the target item and the value of an item attribute of the target item, as well as relative importance of item attributes to each other.

16. The computer program product of claim 11, wherein selecting the set of candidate items for which the online system maintains attributes based on the target embedding and embeddings for items for which the online system maintains attributes comprises:
generating a distance between the target embedding and each of the embeddings for items for which the online system maintains attributes;
ranking the items for which the online system maintains attributes based on the distances; and
selecting items for which the online system maintains attributes having at least a threshold position in the ranking.

17. The computer program product of claim 11, wherein selecting the set of candidate items for which the online system maintains attributes based on the target embedding and embeddings for items for which the online system maintains attributes comprises:
generating a measure of similarity between the target embedding and each of the embeddings for items for which the online system maintains attributes;
ranking the items for which the online system maintains attributes based on the measures of similarity; and
selecting items for which the online system maintains attributes having at least a threshold position in the ranking.

18. The computer program product of claim 11, wherein retrieving the set of item attributes for each candidate item based on attributes maintained by the online system for items comprises:
generating an item category maintained by the online system including a candidate item;
generating a set of item attributes associated with the generated item category; and
retrieving the generated set of item attributes associated with the generated item category for the candidate item.

19. The computer program product of claim 11, wherein generating, by the online system, the target embedding for the target item based on information associated with the target item included in the representation of the document comprises:
generating a combination of identifiers of attributes of the target item included in the representation of the document and corresponding values of the attributes of the target item; and
generating the target embedding based on the combination.

20. A system comprising:
a processor; and
a non-transitory computer readable storage medium having instructions encoded thereon that, when executed by the processor, cause the processor to perform steps comprising:
receiving, at an online system, a representation of a document including one or more items available through a source;
extracting, by the online system, a target item included in the representation of the document;
generating, by the online system, a target embedding for the target item based on information associated with the target item included in the representation of the document;
selecting a set of candidate items for which the online system maintains attributes based on the target embedding and embeddings for items for which the online system maintains attributes;
generating attributes of the target item based on information associated with the target item included in the representation of the document;
retrieving a set of item attributes for each candidate item based on attributes maintained by the online system for items;
selecting a candidate item of the set of candidate items based on values of the attributes of the target item and values of the sets of item attributes for each candidate item; and
generating an interface including information describing the selected candidate item and information associated with the target item included in the representation of the document.
